(19) United States
(12) Patent Application Publication
(10) Pub. No.: US 2023/0350073 A1
(43) Pub. Date: Nov. 2, 2023

(54) EDGE AND GENERATIVE AI-BASED SUSTAINABLE GPS NAVIGATED WEARABLE DEVICE FOR BLIND AND VISUALLY IMPAIRED PEOPLE

(71) Applicants: Sujith Sivaramapillai, Doha (QA); Janita Saji, Bangalore (IN); Sangeeta Sahu, Raipur (IN); Vikas Dubey, Raipur (IN); Neha Dubey, Chhattisgarh (IN); Rohit Miri, Chhattisgarh (IN)

(72) Inventors: Sujith Sivaramapillai, Doha (QA); Janita Saji, Bangalore (IN); Sangeeta Sahu, Raipur (IN); Vikas Dubey, Raipur (IN); Neha Dubey, Chhattisgarh (IN); Rohit Miri, Chhattisgarh (IN)

(73) Assignees: Sujith Sivaramapillai, Doha (QA); Janita Saji, Bangalore (IN); Sangeeta Sahu, Raipur (IN); Vikas Dubey, Raipur (IN); Neha Dubey, Chhattisgarh (IN); Rohit Miri, Chhattisgarh (IN)

(21) Appl. No.: 18/349,216

(22) Filed: Jul. 10, 2023

(51) Int. Cl. G01S 19/14; G06V 20/50

(52) U.S. Cl. CPC G01S 19/14; G06V 20/50; G08B 7/00

(57) ABSTRACT

The present invention relates to an EdgeGenAI based sustainable GPS navigated wearable device (100) for blind and visually impaired people. The device (100) comprises a GPS navigation unit, a plurality of sensor, an obstacle detection unit, a haptic feedback unit, an audio prompts unit, a central processing unit, a power sources and a user interface unit. The GPS navigation unit is configured to provide a real-time positioning and route guidance to the user. The audio prompts unit is configured to provide auditory instructions and information to the user during navigation. The power sources are configured to supply electrical power to the GPS navigation unit, plurality of sensor, obstacle detection unit, audio prompts unit and haptic feedback unit. The user interface unit is configured to provide an intuitive and accessible interface for blind and visually impaired individuals.

### FIELD OF INVENTION

The present invention relates to the technical field of image processing, and more particularly to an EdgeGenAI based sustainable GPS navigated wearable device for blind and visually impaired people.

### BACKGROUND OF THE INVENTION

Walking independently as a blind or visually impaired person can indeed be quite challenging. These individuals face various difficulties and obstacles that can make everyday tasks such as avoiding obstacles, finding crosswalks, or even taking a walk in the park feel stressful. There are some of the problems commonly faced by blind or visually impaired individuals. One of the main challenges is detecting and avoiding obstacles while walking. Without the ability to see, blind individuals rely on alternative methods such as white canes, guide dogs, or their remaining senses to navigate their surroundings. However, some obstacles may go undetected, leading to potential accidents or injuries. Blind individuals often struggle with perceiving and understanding their environment. They may find it difficult to judge distances, identify landmarks, or determine the layout of the surrounding area. This lack of spatial awareness can make it challenging to navigate unfamiliar places. Locating and safely crossing intersections and crosswalks can be a daunting task for blind individuals. Auditory cues like traffic sounds and pedestrian signals are essential, but they may not always be reliable or accessible. Inconsistent or malfunctioning crossing signals can further complicate the process. Additionally, many public spaces and urban environments still lack adequate accessibility measures for the visually impaired. Sidewalks with uneven surfaces, missing or poorly maintained curb cuts, and insufficient tactile markings can create significant barriers to independent travel. Walking independently as a blind person often involves interacting with others, such as asking for directions or seeking assistance. However, some individuals may be unfamiliar or uncomfortable with interacting with blind individuals, leading to potential communication challenges and feelings of isolation. The combination of the above challenges and the inherent vulnerability of not being able to rely on vision can lead to increased levels of anxiety and stress for blind individuals. Everyday activities that sighted people take for granted, like walking in a park, can become stressful experiences for those with visual impairments.

Additionally, increasing awareness about accessibility, improving infrastructure, and fostering inclusive attitudes can help create a more inclusive and accommodating environment for the visually impaired.

Therefore, there remains a need in the art for an EdgeGenAI based sustainable GPS navigated wearable device for blind and visually impaired people that does not suffer from the above-mentioned deficiencies or at least provides a viable and effective solution.

### OBJECTS OF THE INVENTION

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide an EdgeGenAI based sustainable GPS navigated wearable device for blind and visually impaired people

An object of the present disclosure is to provide an EdgeGenAI based sustainable GPS navigated wearable device for blind and visually impaired people that can identify objects and predicts obstacle positions.

An object of the present disclosure is to provide an EdgeGenAI based sustainable GPS navigated wearable device for blind and visually impaired people that can identifies more than twenty classes of objects and get warned through spatial sounds of any important object that is on the way.

An object of the present disclosure is to provide an EdgeGenAI based sustainable GPS navigated wearable device for blind and visually impaired people that can guide user in new environments with simple audio feedback and can also connect user smartphone's GPS to guide to new places.

An object of the present disclosure is to provide an EdgeGenAI based sustainable GPS navigated wearable device for blind and visually impaired people that can even works at night by using its infrared cameras that can avoid any obstacle, any time.

An object of the present disclosure is to provide an EdgeGenAI based sustainable GPS navigated wearable device for blind and visually impaired people that can provide Virtual Volunteer which can read text in multiple language and provide text to speech and speech to speech conversion.

An object of the present disclosure is to provide an EdgeGenAI based sustainable GPS navigated wearable device for blind and visually impaired people that can help in fall detection and providing alarm system which will be sent to relative.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

An embodiment of the present invention provides an EdgeGenAI based sustainable GPS navigated wearable device for blind and visually impaired people. The device comprises a GPS navigation unit, a plurality of sensor, an obstacle detection unit, a haptic feedback unit, an audio prompts unit, a central processing unit, a power sources and a user interface unit. The GPS navigation unit is configured to provide a real-time positioning and route guidance to the user. The plurality of sensors are configured to detect the types and position of obstacles in the user's path. The obstacle detection unit is configured to detect the presence of types of obstacles in the user's path. The haptic feedback unit is configured to provide tactile feedback to the user and generate based on the detected obstacles. The audio prompts unit is configured to provide auditory instructions and information to the user during navigation. The central processing unit is operationally connected with the GPS navigation unit, plurality of sensor, obstacle detection unit, audio prompts unit and haptic feedback unit. The central processing unit is configured to control the function perform by the GPS navigation unit, plurality of sensor, obstacle detection unit, audio prompts unit and haptic feedback unit. The power sources are operationally connected with the GPS navigation unit, plurality of sensor, obstacle detection unit, audio prompts unit and haptic feedback unit. The power sources are configured to supply electrical power to the GPS navigation unit, plurality of sensor, obstacle detection unit, audio prompts unit and haptic feedback unit. The user interface unit is operationally connected with the central processing unit. The user interface unit is configured to provide an intuitive and accessible interface for blind and visually impaired individuals.

In accordance with an embodiment of the present invention, the GPS navigation unit is configured for efficient and fast processing of location data, ensuring reliable and up-to-date navigation assistance.

In accordance with an embodiment of the present invention, the haptic feedback unit configured to convey information to the user as vibrations or gentle pulses, to convey information to the user.

In accordance with an embodiment of the present invention, the power sources includes battery and solar panel.

In accordance with an embodiment of the present invention, the power source is configured to optimize power usage, ensuring prolonged battery life and reducing the need for frequent charging.

### BRIEF DESCRIPTION OF THE DRAWINGS

So that the manner in which the above recited features of the present invention can be understood in detail, a more particular description of the invention, briefly summarized above, may have been referred to by embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits, and advantages of the present invention will become apparent by reference to the following text figure, with like reference numbers referring to like structures across the views, wherein

FIG. 1: Illustrates an EdgeGenAI based sustainable GPS navigated wearable device for blind and visually impaired people, in accordance with an embodiment of the present invention.

FIG. 2: Illustrates a block diagram of EdgeGenAI based sustainable GPS navigated wearable device for blind and visually impaired people, in accordance with an embodiment of the present invention.

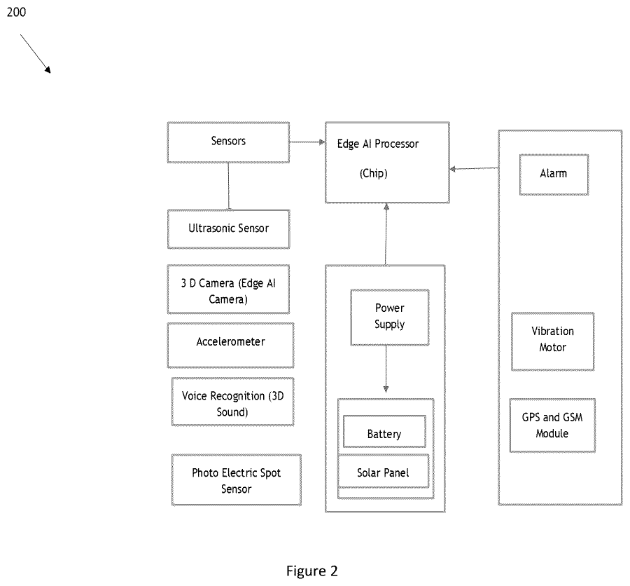

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

While the present invention is described herein by way of example using embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claim. As used throughout this description, the word “may” is used in a permissive sense (i.e. meaning having the potential to), rather than the mandatory sense, (i.e. meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes.

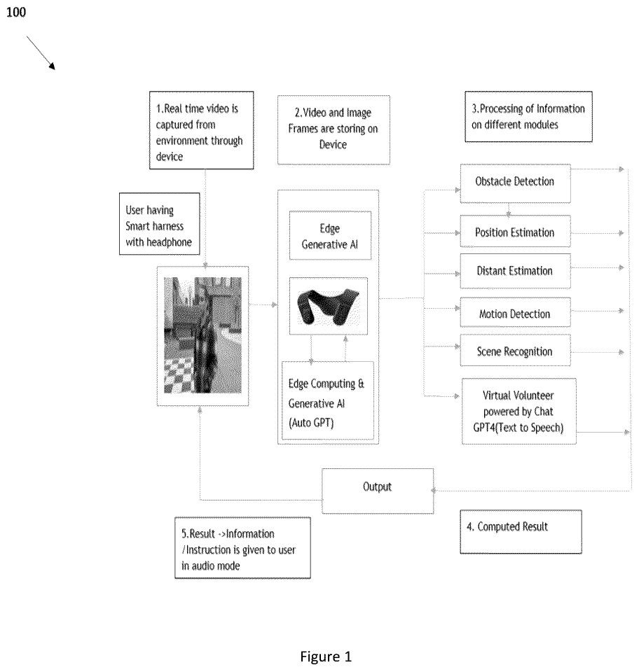

FIG. 1: Illustrates an EdgeGenAI based sustainable GPS navigated wearable device (100) for blind and visually impaired people, in accordance with an embodiment of the present invention. The device (100) comprises a GPS navigation unit, a plurality of sensor, an obstacle detection unit, a haptic feedback unit, a audio prompts unit, a central processing unit, a power sources and a user interface unit. The GPS navigation unit is configured to provide a real-time positioning and route guidance to the user. The plurality of sensors are configured to detect the types and position of obstacles in the user's path. The obstacle detection unit is configured to detect the presence of types of obstacles in the user's path. The haptic feedback unit is configured to provide tactile feedback to the user and generate based on the detected obstacles. The haptic feedback unit is configured to convey information to the user as vibrations or gentle pulses, to convey information to the user. The audio prompts unit is configured to provide auditory instructions and information to the user during navigation. The central processing unit is operationally connected with the GPS navigation unit, plurality of sensor, obstacle detection unit, audio prompts unit and haptic feedback unit. The central processing unit is configured to control the function perform by the GPS navigation unit, plurality of sensor, obstacle detection unit, audio prompts unit and haptic feedback unit. The power sources are operationally connected with the GPS navigation unit, plurality of sensor, obstacle detection unit, audio prompts unit and haptic feedback unit. The power sources are configured to supply electrical power to the GPS navigation unit, plurality of sensor, obstacle detection unit, audio prompts unit and haptic feedback unit. The power sources includes battery and solar panel. The power source is configured to optimize power usage, ensuring prolonged battery life and reducing the need for frequent charging. The user interface unit is operationally connected with the central processing unit. The user interface unit is configured to provide an intuitive and accessible interface for blind and visually impaired individuals.

In accordance with an embodiment of the present invention, the novel EdgeGenAI (Edge Artificial Intelligence and Generative Artificial Intelligence) based sustainable GPS navigated wearable device (100) for blind and visually impaired people. The Edge generative AI is a technology that combines the power of edge AI and generative AI to produce new creative output from existing data. Edge AI incorporates AI capabilities on the edge device (100)s while Generative AI is a type of artificial Intelligence that focuses on creating new data, such as images, videos, audio, or text, that resemble human-made content. EdgeGenAI can run deep-learning algorithms locally, allowing for real-time decisions and create new digital images, video, audio, and text generation using Generative AI. Envision.ai is a harness worn on the shoulders, equipped with ultra-wide angle cameras on the left of your chest, a battery behind your neck, and a small computer having Edge AI processor on the right of your chest. Envision.ai has in-built 3D cameras that can be paired with headphones to warn users about the position of obstacles around them. Placed on the wearer's shoulders, it can predict the trajectories of obstacles around the wearer, similar to an autonomous vehicle. It then provides feedback to the wearer through sound. It can be used for up to six hours at a time and also works in dark locations. It uses wide-angle cameras and AI to generate short sounds to warn blind people about the position of important obstacles, such as branches, holes, vehicles or pedestrians. It also provides GPS instructions.

In accordance with an embodiment of the present invention, the features and application are mentioned below:
The device (100) identifies objects and predicts obstacle positions. Never hit an obstacle again.
It identifies more than 20 classes of objects. Get warned through spatial sounds of any important object that is on the way.
Get guided in new environments with simple audio feedback. Person can also connect smartphone's GPS to guide to new places.
It can even works at night by using its infrared cameras. Avoid any obstacle, any time.
It can provide Virtual Volunteer which can read text in multiple language and provide text to speech and speech to speech conversion.
It can recognize (Fire/Smoke) in case of early warning.
It will help in fall detection and providing alarm system which will be sent to relative

In accordance with an embodiment of the present invention, the intention behind for developing this system is to create a device (100) that is based on Edge Computing and Generative AI for helping Blind and Visually Impaired people using natural language-powered computer vision AI service. The main components of device (100) system are a smart harness with bone conduction headset and six different software modules, namely obstacle detection, distance estimation, position estimation, motion detection, and scene recognition and Virtual Volunteer. Using two relatively lightweight hardware components, such as a smart harness device (100) for capturing and processing information and the bone conduction headset to output navigation. The software behind this device (100) will help in following areas:
1. Avoid Obstacles: The device (100) identifies and predicts obstacle positions. Never hit an obstacle again.
2. Identify important Objects: It identifies more than 20 classes of objects. Get warned through spatial sounds of any important object that is on your way.
3. Navigate unknown places: Get guided in new environments with simple audio feedback. You can also connect your smartphone's GPS.
4. Safety: It can even works at night due to its infrared cameras. Avoid any obstacle, any time.
5. Intuitiveness: It is intuitive to use from the start, and comes with a short training provided via an app.
6. Discover: It can connects to the smartphone's GPS to guide you to new places.

In accordance with an embodiment of the present invention, If the user wearing the system stumbles over, an alarm is triggered to alert people in the surroundings, and an SMS is sent to the family and caregivers reporting the incident. Likewise, if the user requires help, she can say the word “Help” for the system to trigger the corresponding alarm, which alerts people in the surroundings and sends an SMS to the family and caregivers with information on the user location and asking to contact her. Moreover, the family and caregivers can request the system location by sending an SMS, thus allowing to locate and track the device (100) when needed, such as when the user should be located or when the system is stolen or lost.

In accordance with an embodiment of the present invention, the AI based camera systems use video-based fire detection to quickly identify smoldering and small fires directly at the source. This means the fire alarm doesn't have to wait for smoke to physically reach its sensors, thus wasting valuable time before alerting safety teams. The goal is to utilize a state-of-the-art deep neural network for detecting fire and smoke in outdoor and indoor environments using cameras on embedded system.

In accordance with an embodiment of the present invention, the AI processing is used to train the object images in the processor. If any objects/obstacles approach the blind person, then the processor alerts the person by a voice message. This can make the blind person more cautious and thereby lowers the possibilities of accidents.

In accordance with an embodiment of the present invention, the Edge AI system consists of a camera, AI processing, controller and voice alert. The ultimate goal of this smart navigation system is to detect the obstacles coming in front of the visually impaired person and to inform them about the object. A camera is used to capture the indoor and outdoor images which help the smart navigation system to detect the obstacle.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation

1. A EdgeGenAI based sustainable GPS navigated wearable device (100) for blind and visually impaired people, comprising:
a GPS navigation unit configured to provide a real-time positioning and route guidance to the user;
a plurality of sensor configured to detect the types of obstacles in the user's path;
an obstacle detection unit configured to detect the presence of types of obstacles in the user's path;
a haptic feedback unit configured to provide tactile feedback to the user and generate based on the detected obstacles;
a audio prompts unit configured to provide auditory instructions and information to the user during navigation;
a central processing unit operationally connected with the GPS navigation unit, plurality of sensor, obstacle detection unit, audio prompts unit and haptic feedback unit, configured to control the function perform by the GPS navigation unit, plurality of sensor, obstacle detection unit, audio prompts unit and haptic feedback unit;
a power sources operationally connected with the GPS navigation unit, plurality of sensor, obstacle detection unit, audio prompts unit and haptic feedback unit, configured to supply electrical power to the GPS navigation unit, plurality of sensor, obstacle detection unit, audio prompts unit and haptic feedback unit;
a user interface unit operationally connected with the central processing unit, configured to provide an intuitive and accessible interface for blind and visually impaired individuals.

2. The wearable device (100) as claimed in claim 1, wherein the GPS navigation unit is configured for efficient and fast processing of location data, ensuring reliable and up-to-date navigation assistance.

3. The wearable device (100) as claimed in claim 1, wherein the haptic feedback unit configured to convey information to the user as vibrations or gentle pulses, to convey information to the user.

4. The wearable device (100) as claimed in claim 1, wherein the power sources includes battery and solar panel.

5. The wearable device (100) as claimed in claim 1, wherein the power sources configured to optimize power usage, ensuring prolonged battery life and reducing the need for frequent charging.
